(19) United States
(12) Patent Application Publication
(10) Pub. No.: US 2009/0147539 A1
(43) Pub. Date: Jun. 11, 2009

(54) Optical assembly

(76) Inventors: Hsu-Tsu Wang, Jhonghe City (TW); Ching-Hung Chen, Jhongli City (TW); Tzu-Wei Wang, Bade City (TW); Tzeng-Guang Tsai, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,277

(22) Filed: Jul. 18, 2008

(30) Foreign Application Priority Data
Dec. 7, 2007 (CN) 200710032346.X

(51) Int. Cl. F21V 7/04

(52) U.S. Cl. 362/623

(57) ABSTRACT

An optical assembly includes a light source for generating and emitting light, a light guide plate, and a light transmissive plate. The light transmissive plate is disposed above the light guide plate and has a plurality of asymmetric V-shaped structures on a bottom surface thereof. The V-shaped structures may divert the light emitted from an optical element to exit at a collimation angle, thereby enhancing a light utilization, reducing loss of the light, and facilitating the enhancement of a positive gray level. Further, the optical assembly has a simple structure and a low cost.

### CROSS-REFERENCE TO RELATED APPLICATIONS

This non-provisional application claims priority under 35 U.S.C. §119(a) on Patent Application No(s). 200710032346.X filed in China, P.R.C. on Dec. 7, 2007 the entire contents of which are hereby incorporated by reference.

### BACKGROUND OF THE INVENTION

1. Field of Invention

The present invention relates to an optical assembly, in particularly, to an optical assembly having a fine light converging effect.

2. Related Art

In the prior art, light guide plates are important elements in backlight modules. Since most of the light passing through the light guide plates are emitted at larger angle, in order to control the emitting angle, brightness enhance films (BEF) are often employed in this industry. The brightness enhance films may reflect light at larger angle back to the light guide plates in a circulation manner, so as to control the emitting angle of the light.

However, the aforementioned technique still has deficiencies of great loss of efficiency since the light in circulation passes through multiple interfaces and furthermore and a high cost due to the use of the BEF.

### SUMMARY OF THE INVENTION

In view of the aforementioned problem, the present invention provides an optical assembly which may enhance the use efficiency of a light source and have a low cost.

In order to achieve the aforementioned objective, the present invention provides the technical solution that includes a light source for generating and emitting light, a light guide plate, and a light transmissive plate. The light guide plate includes a first light incident surface, and a first light reflecting surface and a first light-exiting surface connected to the first light incident surface respectively. Light emitted from the light source is incident into the first light incident surface, and the first light-exiting surface and the first light reflecting surface are disposed opposite to each other. The light transmissive plate includes a bottom surface and a second light-exiting surface. The light transmissive plate and the light guide plate are disposed opposite to each other with the bottom surface of the light transmissive plate facing the first light-exiting surface of the light guide plate. The bottom surface has a plurality of V-shaped structures.

The V-shaped structures are asymmetric V-shaped structures.

The V-shaped structures are bar-shaped structures arranged side by side.

The V-shaped structures and the light transmissive plate are integrally formed.

The light transmissive plate is a plastic plate.

Each of the V-shaped structures has an incident surface, and an included angle formed between the incident surface and the bottom surface of the light transmissive plate is in a range of 70°-115°.

Each of the V-shaped structures has a light reflecting surface, and the included angle formed between the light reflecting surface and the light transmissive plate is in a range of 30°-60°.

The present invention is also directed to enhance a positive gray level of the light guide plate, so as to provide a fine light converging effect.

In order to achieve the aforementioned objectives, the present invention is further characterized in that the second light-exiting surface has a plurality of rectangular pyramids.

The rectangular pyramids are distributed in an array on the second light-exiting surface.

The rectangular pyramids and the light transmissive plate are integrally formed.

Compared with the prior art, the structure of the present invention has the following advantages. That is, light at larger angle will be normally reflected by the V-shaped structures disposed on the bottom surface of the light transmissive plate, so as to be collimated. This structure may convert the angles of the light emitted from the light guide plate, have a low cost, enhance the light utilization, and facilitates the enhancement of the positive gray level of the optical assembly.

In addition, a plurality of rectangular pyramids is disposed on the bottom surface of the light transmissive plate. The light may be centrally converged along two axes, thereby achieving the light converging effect. The micro rectangular pyramids on the light transmissive plate may be formed by means of punching which is simple and costs less. Furthermore, the asymmetric V-shaped structures disposed on a second light incident surface of the light transmissive plate may divert the light to the collimation angle, and then the light are then converged by the micro rectangular pyramids, thereby achieving a better light converging effect.

Definitely, in order to reduce the thickness of the backlight module, a wedged light guide plate may be adopted. The wedged structure of the light transmissive plate is in a direction opposite to that of the light guide plate.

### BRIEF DESCRIPTION OF THE DRAWINGS

The present invention will become more fully understood from the detailed description given herein below for illustration only, and thus are not limitative of the present invention, and wherein:

FIG. 1 is a perspective view of a first embodiment of the present invention;

FIG. 2 is a perspective view of V-shaped structures in the present invention;

FIG. 3 is a perspective view of a second embodiment of the present invention; and

FIG. 4 is a perspective view of rectangular pyramids in the present invention.

### DETAILED DESCRIPTION OF THE INVENTION

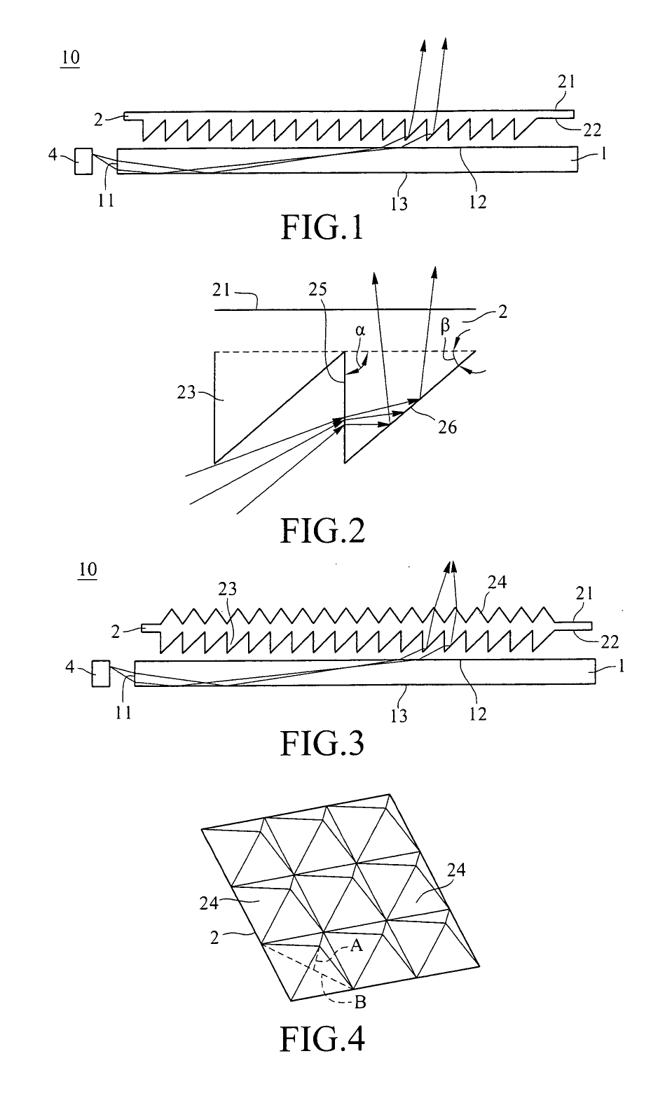

Please refer to FIG. 1, in the first embodiment of the present invention, a backlight module 10 applied in an LCD screen includes a light source 4 and a flat light guide plate 1. The light guide plate 1 includes a first light incident surface 11, and a first light reflecting surface 13 (i.e., the bottom surface) and a first light-exiting surface 12 connected to the first light incident surface 11. A light transmissive plate 2 is disposed above the light guide plate 1 and has a similar shape of the light guide plate 1 and includes a bottom surface 22 and a second light-exiting surface 21. The light transmissive plate 2 is a plastic plate.

Referring to FIGS. 1 and 2, a plurality of V-shaped structures 23 protrude from the bottom surface 22 of the light transmissive plate 2. The V-shaped structures may be integrally formed with the light transmissive plate 2 by a fly-cut technique which is cheaper. The V-shaped structures are asymmetric, i.e., the triangles formed by the V-shaped structures are not isosceles triangles. The V-shaped structures are bar-shaped structures arranged side by side.

As shown in FIGS. 1 and 2, the light generated and emitted by the light source 4 after passing through and being refracted by the first light incident surface 11 are incident on and reflected by the first light reflecting surface 13, and then exit from the first light-exiting surface 12. Most of the light rays reflected from the first light-exiting surface 12 are at larger angle. Therefore, the light at larger angle are incident on and refracted by the second light incident surfaces 25 of the V-shaped structures on the bottom surface 22 of the light transmissive plate 2, then incident on and reflected by second light reflecting surfaces 26 of the V-shaped structures, and finally incident on and exit from the second light-exiting surface 21 of the light transmissive plate 2. In this manner, the angles of the exit light may be converted and controlled, and thus the light exit in the collimation angle, thereby enhancing the positive gray level (brightness) of the optical element.

The included angles a formed between the second light incident surfaces 25 of the V-shaped structures 23 and the bottom surface of the light transmissive plate 2 are larger than the included angles β formed between the second light reflecting surfaces 26 of the V-shaped structures 23 and the light transmissive plate 2. The included angles a are in a range of 70°-150°, and the included angles β are in a range of 30°-60°, such that the included angles α and β are adjusted to control the angles of the light exiting from the second light-exiting surface 21 of the light transmissive plate 2, i.e., the optical element.

FIGS. 3 and 4 show the second embodiment of the present invention. The second embodiment is substantially the same as the aforementioned embodiment, except that in addition to the aforementioned structure, a plurality of micro rectangular pyramids 24 protrudes from the second light-exiting surface 21 of the light transmissive plate 2. The micro rectangular pyramids 24 may be formed integrally with the light transmissive plate 2 by a fly-cut technology which is cheaper. The micro rectangular pyramids 24 are uniformly and continuously disposed on the second light-exiting surface 21. Each micro rectangular pyramid 24 is a rhombic pyramid.

The light, reflected by the second light reflecting surfaces 26 of the V-shaped structures, are incident on and refracted by pyramidal faces of the rectangular pyramids 24. In this manner, the originally scattered light may be centrally converged to achieve the light converging effect. Therefore, the micro rectangular pyramids 24 may enhance the gray level of the light emitted from the light transmissive plate 2, thereby achieving the light converging effect.

The light source 4 may be a spot or linear light source, such as an LED or a cold cathode lamp. A unit, such as a lamp shade, may be added beside the light source, so as to enhance the utilization.

The light guide plate 1, the light transmissive plate 2, the rectangular pyramids 24, and the V-shaped structures 23 may be made of a material having a good light (visible light) transmissive property, such as glass or polyester material.

In order to reduce the thickness of the structure in the aforementioned embodiments, a wedged light guide plate may be used. Definitely, the wedged structure of the light transmissive plate is in a direction opposite to that of the light guide plate.

In consideration of different requirements on structures or effects, the length of the micro rectangular pyramids 24 may be designed along the axis A or B, so as to control the angles of light exiting from the micro rectangular pyramids.

What is claimed is:

1. An optical assembly, comprising:
a light source, for generating and emitting light;
a light guide plate, having a first light incident surface, a first light reflecting surface and a first light-exiting surface connected to the first light incident surface respectively, wherein light emitted from the light source are incident into the first light incident surface, and the first light-exiting surface and the first light reflecting surface are disposed opposite to each other; and
a light transmissive plate, having a bottom surface and a second light-exiting surface, wherein the light transmissive plate and the light guide plate are disposed opposite to each other, so that the bottom surface faces the first light-exiting surface of the light guide plate and the bottom surface has a plurality of V-shaped structures.

2. The optical assembly according to claim 1, wherein the V-shaped structures are asymmetric V-shaped structures.

3. The optical assembly according to claim 1, wherein the V-shaped structures are bar-shaped structures arranged side by side.

4. The optical assembly according to claim 1, wherein the V-shaped structures and the light transmissive plate are integrally formed.

5. The optical assembly according to claim 1, wherein the light transmissive plate is a plastic plate.

6. The optical assembly according to claim 1, wherein each of the V-shaped structures has a second incident surface, and an included angle formed between the second incident surface and the bottom surface of the light transmissive plate is in a range of 70°-115°.

7. The optical assembly according to claim 1, wherein each of the V-shaped structures has a second light reflecting surface, and a included angle formed between the second light reflecting surface and the light transmissive plate is in a range of 30°-60°.

8. The optical assembly according to claim 1, wherein the second light-exiting surface has a plurality of rectangular pyramids.

9. The optical assembly according to claim 8, wherein the rectangular pyramids are distributed in an array on the second light-exiting surface.

10. The optical assembly according to claim 8, wherein the rectangular pyramids and the light transmissive plate are integrally formed.
